(19) United States
(12) Patent Application Publication
(10) Pub. No.: US 2013/0278487 A1
(43) Pub. Date: Oct. 24, 2013

(54) LAYOUT STRUCTURE AND PIXEL STRUCTURE OF DISPLAY PANEL

(71) Applicant: Hung-Lung Hou, Shenzhen (CN)

(72) Inventor: Hung-Lung Hou, Shenzhen (CN)

(73) Assignee: SHENZHEN CHINA STAR OPTOELECTRONICS TECHNOLOGY CO LTD., Shenzhen (CN)

(21) Appl. No.: 13/522,702

(22) PCT Filed: Apr. 23, 2012
(86) PCT No.: PCT/CN12/74553

§ 371 Date: Jul. 17, 2012

(30) Foreign Application Priority Data
Apr. 19, 2012 (CN) 201210116150.X

(51) Int. Cl. G09G 3/18

(52) U.S. Cl. CPC G09G 3/18
USPC 345/87

(57) ABSTRACT

A layout structure of a display panel is disclosed. The layout structure comprises: a plurality of gate lines; a plurality of source lines which are interlaced with the gate lines to construct a plurality of pixel units; and a plurality of connecting lines which are electrically connected to the gate lines or the source lines in a one-to-one relationship and are extended to the same side or two corresponding sides of the display panel. The present invention can reduce the layout area of the source driver and the gate driver. It is quite beneficial to the development on narrow-border display products.

### TECHNICAL FIELD OF THE INVENTION

The present invention relates to a display panel, and more particularly, to a layout structure and a pixel structure of a display panel.

### BACKGROUND OF THE INVENTION

Nowadays, display panels (e.g., liquid crystal display panels) are developed with a tendency to become light and thin. The borders of the display panels are designed into narrower and narrower ones. The narrow-borders display products are likely to become a mainstream in further market.

FIG. 1 is a schematic diagram showing a conventional display panel. FIG. 2 is a schematic diagram showing a layout structure of the display panel shown in FIG. 1. The conventional layout structure of the display panel comprises a plurality of gate lines 11, a plurality of source lines 12, and common lines 15. The gate lines 11 and the source lines 12 are interlaced with each other and thereby constructing a plurality of pixel units 10 therebetween. Each pixel unit 10 has a transistor 18 and a pixel electrode 19 disposed therein. The transistor 18 is utilized to control the reception of pixel data and the pixel electrode 19 is utilized to provide a driving voltage for twisting liquid crystal molecules.

In general, there are two types of gate driving methods. One is single-side driving, wherein one gate driver is disposed at one side of the display panel. The other is double-side driving, wherein both sides of the display panel have gate drivers 1, 2 disposed therein, as shown in FIG. 1. The output terminals of the gate drivers 1, 2 are connected to the gate lines 11 for outputting scan signals. The output terminal of a source driver 3 is connected to the source lines 12 for outputting data signals.

No matter for the single-side driving or the double-side driving, in the conventional layout structure of the display panel, the gate driver and the source driver mush be arranged at different sides of the display panel. In this way, the gate driver and the source driver will occupy quite a large area in the display panel. This is not beneficial to the development on narrow-border display products.

### SUMMARY OF THE INVENTION

An objective of the present invention is to provide a layout structure and a pixel structure of a display panel, for reducing a layout area of a source driver and a gate driver, thereby reducing the size of border for a display product.

To achieve the above objectives, the present invention provides a layout structure of a display panel, comprising: a plurality of gate lines; a plurality of source lines, which are interlaced with the gate lines to construct a plurality of pixel units; and a plurality of source connecting lines, which are parallel to the gate lines, wherein corresponding ends of the source connecting lines are electrically connected to the source lines in a one-to-one relationship via a plurality of connecting points, respectively.

According to an embodiment of the present invention, the display panel comprises a source driver, another set of corresponding ends of the source connecting lines is electrically connected to an output terminal of the source driver for receiving data signals outputted from the source driver.

According to an embodiment of the present invention, the display panel comprises a first metal layer, a second metal layer, and an insulating layer located between the first metal layer and the second metal layer, wherein the gate lines are formed in the first metal layer, the source lines are formed in the second metal layer, and the source connecting lines are formed in the first metal layer and are electrically connected to the source lines formed in the second metal layer via contact holes.

According to an embodiment of the present invention, the layout structure further comprises a plurality of common lines, which are formed in the second metal layers and are parallel to the source lines, wherein the common lines have shield structures disposed corresponding to a region where the source connecting lines pass by.

In another aspect, the present invention provides a layout structure of a display panel, comprising: a plurality of gate lines; a plurality of source lines, which are interlaced with the gate lines to construct a plurality of pixel units; and a plurality of connecting lines, which are electrically connected to the gate lines or the source lines in a one-to-one relationship and are extended to the same side or two corresponding sides of the display panel.

According to an embodiment of the present invention, the connecting lines are source connecting lines which are parallel to the gate lines, corresponding ends of the source connecting lines are electrically connected to the source lines via a plurality of connecting points, respectively.

According to an embodiment of the present invention, the display panel comprises a source driver, another set of corresponding ends of the source connecting lines are electrically connected to an output terminal of the source driver for receiving data signals outputted from the source driver.

According to an embodiment of the present invention, the display panel comprises a first metal layer, a second metal layer, and an insulating layer located between the first metal layer and the second metal layer, wherein the gate lines are formed in the first metal layer, the source lines are formed in the second metal layer, and the source connecting lines are formed in the first metal layer and are electrically connected to the source lines formed in the second metal layer via contact holes.

According to an embodiment of the present invention, the layout structure further comprises a plurality of common lines, which are formed in the second metal layers and are parallel to the source lines, wherein the common lines have shield structures disposed corresponding to a region where the source connecting lines pass by.

According to an embodiment of the present invention, the connecting lines are gate connecting lines which are parallel to the source lines, corresponding ends of the gate connecting lines are electrically connected to the gate lines via a plurality of connecting points, respectively.

According to an embodiment of the present invention, the display panel comprises a gate driver, another set of corresponding ends of the gate connecting lines is electrically connected to an output terminal of the gate driver for receiving scan signals outputted from the gate driver.

According to an embodiment of the present invention, the display panel comprises a first metal layer, a second metal layer, and an insulating layer located between the first metal layer and the second metal layer, wherein the gate lines are formed in the first metal layer, the source lines are formed in the second metal layer, and the gate connecting lines are formed in the second metal layer and are electrically connected to the gate lines formed in the first metal layer via contact holes.

In yet another aspect, the present invention provides a pixel structure of a display panel, having a transistor, in which the pixel structure is constructed by interlacing two gate lines with two source lines, one gate line that corresponds to the pixel structure transmits a scan signal for turning on the transistor of the pixel structure, and one data line that corresponds to the pixel structure transmits a data signal to the pixel structure when the transistor is turned on, wherein the pixel structure comprises: a connecting line which is electrically connected to the gate line corresponding to the pixel structure or the source line corresponding to the pixel structure, and is extended to an external portion.

According to an embodiment of the present invention, the connecting line is a source connecting line which is parallel to the two gate lines, the source connecting line is electrically connected to the source line that corresponds to the pixel structure via a connecting point.

According to an embodiment of the present invention, the connecting line is a gate connecting line which is parallel to the two source lines, the gate connecting line is electrically connected to the gate line that corresponds to the pixel structure via a connecting point.

The layout structure of the display panel of the present invention has a plurality of connecting lines, which are electrically connected to the gate lines or the source lines in a one-to-one relationship and are extended to the same side or two corresponding sides of the display panel, thereby reducing the layout area of the source driver and the gate driver. It is quite beneficial to the development on narrow-border display products.

To make above content of the present invention more easily understood, it will be described in details by using preferred embodiments in conjunction with the appending drawings.

### BRIEF DESCRIPTION OF THE DRAWINGS

FIG. 1 is a schematic diagram showing a conventional display panel.

FIG. 2 is a schematic diagram showing a layout structure of the display panel shown in FIG. 1.

FIG. 3A is a schematic diagram showing a layout structure of a display panel implemented according to a first embodiment of the present invention.

FIG. 3B is a schematic diagram showing a pixel structure shown in FIG. 3A.

FIG. 3C is a schematic diagram showing another pixel structure shown in FIG. 3A.

FIG. 4A is a schematic diagram showing a layout structure of a display panel implemented according to a second embodiment of the present invention.

FIG. 4B is a schematic diagram showing a pixel structure shown in FIG. 4A.

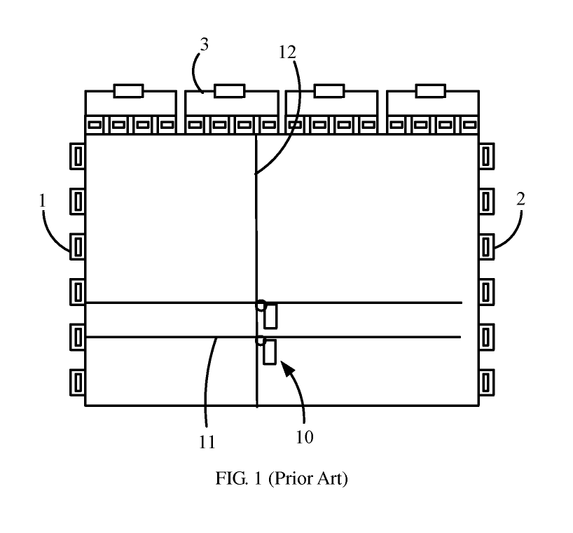

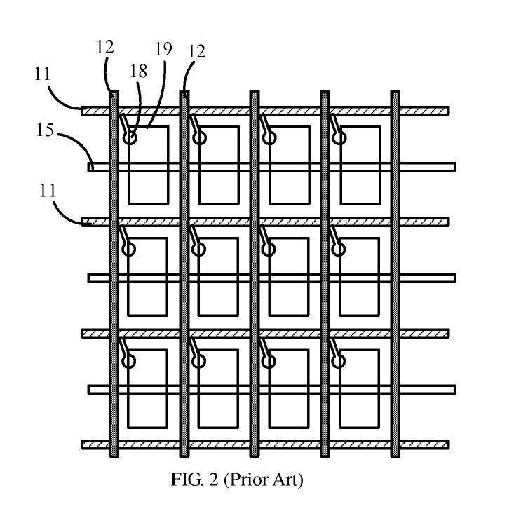

### DETAILED DESCRIPTION OF THE INVENTION

The following descriptions for the respective embodiments are specific embodiments capable of being implemented for illustrations of the present invention with referring to appended figures. In the descriptions of the present invention, spatially relative terms, such as “upper”, “lower”, “front”, “back”, “left”, “right”, “top”, “bottom”, “horizontal”, “vertical”, and the like, may be used herein for ease of description as illustrated in the figures. Therefore, it will be understood that the spatially relative terms are intended to illustrate for understanding the present invention, but not to limit the present invention.

The layout structure of the display panel provided in the present invention adopts a set of connecting lines for connecting source lines in a one-to-one relationship (or connecting gate lines in a one-to-one relationship). This set of connecting lines is also extended to the same side or two corresponding sides of the display panel, and then is directly connected to a source driver (or a gate driver) of the display panel. By this way, both of the source driver and the gate driver can be arranged at the same side or two opposite sides of the display panel, thereby reducing the layout area of the source driver and the gate driver. It is quite beneficial to the development on narrow-border display products.

The present invention will be illustrated by following two embodiments. The first embodiment is that corresponding ends of the connecting lines (called source connecting lines herein) are electrically connected to the source lines in a one-to-one relationship and another set of corresponding ends of the source connecting lines is connected to an output terminal of the source driver. That is to say, the source connecting lines will directly receive data signals outputted from the source driver and then transmit the data signals to the source lines via connecting points that are located between the source connecting lines and the source lines. The second embodiment is that corresponding ends of the connecting lines (called gate connecting lines herein) are electrically connected to the gate lines in a one-to-one relationship and another set of corresponding ends of the gate connecting lines is connected to an output terminal of the gate driver. That is to say, the gate connecting lines will directly receive scan signals outputted from the gate driver and then transmit the scan signals to the gate lines via connecting points that are located between the gate connecting lines and the gate lines.

The present invention also discloses a pixel structure of a display panel. The pixel structure has a connecting line. One end of the connecting line is electrically connected to a gate line that corresponds to the pixel structure (or a source line that corresponds to the pixel structure), and the other end of the connecting line is extended to an external portion or a portion outside the pixel structure.

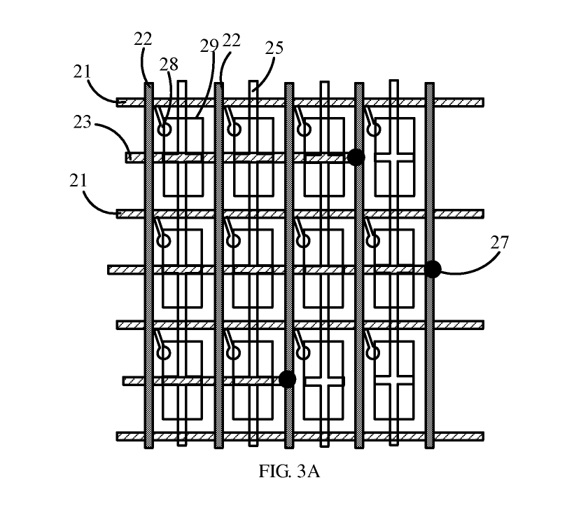

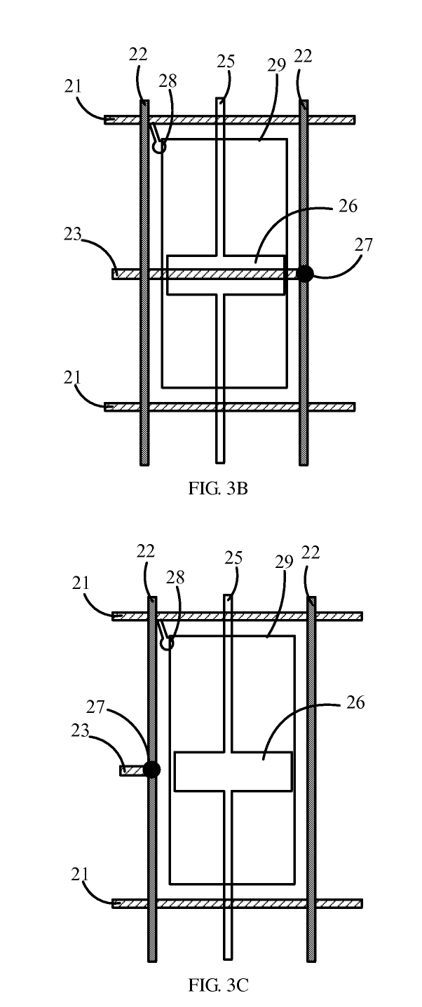

FIG. 3A is a schematic diagram showing a layout structure of a display panel implemented according to a first embodiment of the present invention. FIG. 3B is a schematic diagram showing a pixel structure shown in FIG. 3A. FIG. 3C is a schematic diagram showing another pixel structure shown in FIG. 3A.

As shown in FIG. 3A, the layout structure of the display panel implemented according to the first embodiment of the present invention comprises a plurality of gate lines 21 arranged in a horizontal direction and a plurality of source lines 22 arranged in a vertical direction. The gate lines 21 and the source lines 22 are interlaced with each other and thereby constructing a plurality of pixel units therebetween. Each pixel unit has a transistor 28 and a pixel electrode 29 disposed therein. The transistor 28 is utilized to control the reception of pixel data and the pixel electrode 29 is utilized to provide a driving voltage for twisting liquid crystal molecules.

The layout structure of the first embodiment of the present invention further comprises a plurality of source connecting lines 23, which are parallel to the gate lines 21. Corresponding ends of the source connecting lines 23 are electrically connected to the source lines 22 in a one-to-one relationship via a plurality of connecting points 27, respectively. Another set of corresponding ends of the source connecting lines 23 is connected to an output terminal of a source driver. That is to say, the source connecting lines 23 will directly receive data signals outputted from the source driver and then transmit the data signals to the source lines 22 via the connecting points 27 that are located between the source connecting lines 23 and the source lines 22.

In practical operations, a gate driver outputs scan signals according to a scanning sequence. The scan signals are transmitted to each row of pixel units by the gate lines from top to bottom so as to turn on each row of the transistors 28 in order. Take a single pixel unit for illustration. When the transistor 28 is turned on, the data signal outputted from the source driver is transmitted to the pixel unit sequentially by the source connecting line 23 and the source line 22.

In one embodiment, the source connecting lines 23 are extended to the same side of the display panel and then connected to the source driver located at the side. For example, the source connecting lines 23 are extended to the left side of the display panel, and both of the source driver and the gate driver are disposed at the left side of the display panel. In another embodiment, the source connecting lines 23 are extended to two opposite sides of the display panel, and then respectively connected to two source drivers located at the two sides of the display panel.

In one embodiment, one source connecting line 23 is disposed between every two gate lines 21, as shown in FIG. 3. In another embodiment, when the number of the gate lines 21 is not equal to the number of the source lines 22, two or more source connecting lines 23 can be disposed between every two gate lines 21. The two source connecting lines 23 can be extended to the same side of the display panel or respectively extended to two opposite sides of the display panel.

In one embodiment, one source connecting line 23 can be extended from the connecting point 27 to merely one side of the display panel, as shown in FIG. 3. In another embodiment, however, one source connecting line 23 can be extended from the connecting point 27 to two opposite sides of the display panel.

The manufacturing process of the display panel will sequentially form a first metal layer, a first insulating layer, a semiconductor layer, a second metal layer, a second insulating layer, and a transparent conductive layer. In the present embodiment, the gate lines 21 and the source connecting lines 23 can be formed in the first metal layer, as shown in regions filled by oblique lines in FIG. 3. The source lines 22 can be formed in the second metal layer, as shown in regions filled by dots in FIG. 3. The source connecting lines 23 formed in the first metal layer are electrically connected to the source lines 22 formed in the second metal layer, via the connecting points 27 formed corresponding to contact holes.

The layout structure of the first embodiment of the present invention further comprises a plurality of common lines 25, which are parallel to the source lines 22. For example, one common line 25 is disposed between every two source lines 22. In one embodiment, the common lines 25 can be formed in the second metal layer. The common lines 25 have shield structures 26 disposed corresponding to a region where the source connecting lines 23 pass by. Since the shield structures 26 are disposed between the transparent conductive layer (serving as pixel electrodes) and the source connecting lines 23 formed in the first metal layer, the shield structures 26 have a metal shield function that can prevent the voltages of source connecting lines 23 from being affected by the voltages of the pixel electrodes.

The present invention also discloses a pixel structure of a display panel. As shown in FIG. 3C, the pixel structure has a transistor 28. The pixel structure is constructed by interlacing two gate lines 21 with two source lines 22. One gate line 21 that corresponds to the pixel structure transmits a scan signal for turning on the transistor 28 of the pixel structure, and one data line 22 that corresponds to the pixel structure transmits a data signal to the pixel structure when the transistor 28 is turned on. The pixel structure further comprises a source connecting line 23, which is parallel to the two gate lines 21. The source connecting line 23 is electrically connected to the source line 22 that corresponds to the pixel structure via a connecting point 27. Also, the source connecting line 23 is extended to an external portion or a portion outside the pixel structure.

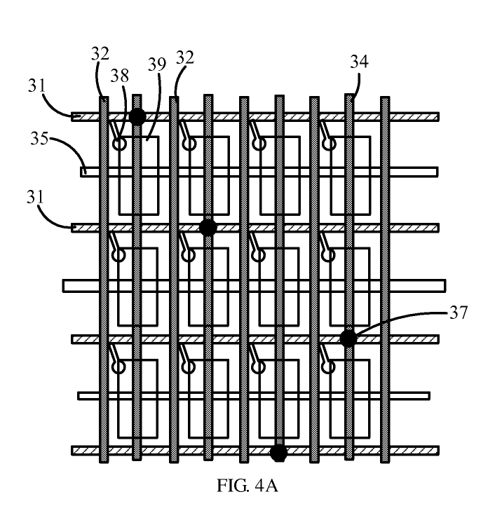

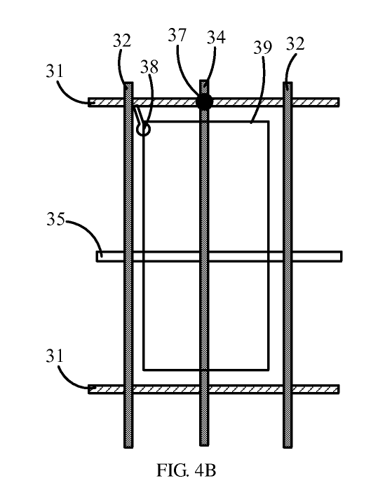

FIG. 4A is a schematic diagram showing a layout structure of a display panel implemented according to a second embodiment of the present invention. FIG. 4B is a schematic diagram showing a pixel structure shown in FIG. 4A.

As shown in FIG. 4A, the layout structure of the display panel implemented according to the second embodiment of the present invention comprises a plurality of gate lines 31 arranged in a horizontal direction and a plurality of source lines 32 arranged in a vertical direction. The gate lines 31 and the source lines 32 are interlaced with each other and thereby constructing a plurality of pixel units therebetween. Each pixel unit has a transistor 38 and a pixel electrode 39 disposed therein. The transistor 38 is utilized to control the reception of pixel data and the pixel electrode 39 is utilized to provide a driving voltage for twisting liquid crystal molecules.

The layout structure of the second embodiment of the present invention further comprises a plurality of gate connecting lines 34, which are parallel to the source lines 32. Corresponding ends of the gate connecting lines 34 are electrically connected to the gate lines 31 in a one-to-one relationship via a plurality of connecting points 37, respectively. Another set of corresponding ends of the gate connecting lines 34 is connected to an output terminal of a gate driver. That is to say, the gate connecting lines 34 will directly receive scan signals outputted from the gate driver and then transmit the scan signals to the gate lines 32 via connecting points 37 that are located between the gate connecting lines 34 and the gate lines 31.

In practical operations, a gate driver outputs the scan signals according to a scanning sequence. The scan signals are transmitted to the gate lines 31 respectively via the gate connecting lines 34 for scanning each row of pixel units from top to bottom so as to turn on each row of the transistors 28 in order. Take a single pixel unit for illustration. When the transistor 28 is turned on, a data signal outputted from a source driver is transmitted to the pixel unit by the source line 22.

In one embodiment, one gate connecting line 34 can be extended from the connecting point 37 to two opposite sides of the display panel, as shown in FIG. 4. In another embodiment, however, one gate connecting line 34 can be extended from the connecting point 37 to merely one side of the display panel.

In one embodiment, the gate connecting lines 34 are extended to the same side of the display panel and then connected to the gate driver located at the side. For example, the gate connecting lines 34 are extended to the upper side of the display panel, and both of the source driver and the gate driver are disposed at the upper side of the display panel. In another embodiment, the gate connecting lines 34 are extended to an upper side and a lower side of the display panel, and then respectively connected to two gate drivers located at the upper side and the lower side of the display panel.

In one embodiment, one gate connecting line 34 is disposed between every two source lines 34, as shown in FIG. 4. In another embodiment, when the number of the gate lines 31 is not equal to the number of the source lines 32, two or more gate connecting lines 34 can be disposed between every two source lines 32. The two gate connecting lines 34 can be extended to the same side of the display panel or respectively extended to the upper side and the lower side of the display panel.

The manufacturing process of the display panel will sequentially form a first metal layer, a first insulating layer, a semiconductor layer, a second metal layer, a second insulating layer, and a transparent conductive layer. In the present embodiment, the gate lines 31 can be formed in the first metal layer, as shown in regions filled by oblique lines in FIG. 4. The gate connecting lines 34 and the source lines 32 can be formed in the second metal layer, as shown in regions filled by dots in FIG. 4. The gate connecting lines 34 formed in the second metal layer are electrically connected to the gate lines 31 formed in the first metal layer, via the connecting points 37 formed corresponding to contact holes.

The layout structure of the second embodiment of the present invention further comprises a plurality of common lines 35, which are parallel to the gate lines 31. For example, one common line 35 is disposed between every two gate lines 31. In one embodiment, the common lines 35 can be formed in the first metal layer.

The present invention also discloses a pixel structure of a display panel. As shown in FIG. 4B, the pixel structure has a transistor 38. The pixel structure is constructed by interlacing two gate lines 31 with two source lines 32. One gate line 31 that corresponds to the pixel structure transmits a scan signal for turning on the transistor 38 of the pixel structure, and one data line 32 that corresponds to the pixel structure transmits a data signal to the pixel structure when the transistor 38 is turned on. The pixel structure further comprises a gate connecting line 34, which is parallel to the two source lines 32. The gate connecting line 34 is electrically connected to the gate line 31 that corresponds to the pixel structure via a connecting point 37. Also, the gate connecting line 34 is extended to an external portion or a portion outside the pixel structure.

The layout structure of the display panel of the present invention has a plurality of connecting lines, which are electrically connected to the gate lines or the source lines in a one-to-one relationship and are extended to the same side or two corresponding sides of the display panel, thereby reducing the layout area of the source driver and the gate driver. It is quite beneficial to the development on narrow-border display products.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A layout structure of a display panel, comprising:
a plurality of gate lines;
a plurality of source lines, which are interlaced with the gate lines to construct a plurality of pixel units; and
a plurality of source connecting lines, which are parallel to the gate lines, wherein corresponding ends of the source connecting lines are electrically connected to the source lines in a one-to-one relationship via a plurality of connecting points, respectively.

2. The layout structure according to claim 1, wherein the display panel comprises a source driver, another set of corresponding ends of the source connecting lines is electrically connected to an output terminal of the source driver for receiving data signals outputted from the source driver.

3. The layout structure according to claim 2, wherein the display panel comprises a first metal layer, a second metal layer, and an insulating layer located between the first metal layer and the second metal layer, wherein the gate lines are formed in the first metal layer, the source lines are formed in the second metal layer, and the source connecting lines are formed in the first metal layer and are electrically connected to the source lines formed in the second metal layer via contact holes.

4. The layout structure according to claim 3, further comprising a plurality of common lines, which are formed in the second metal layers and are parallel to the source lines, wherein the common lines have shield structures disposed corresponding to a region where the source connecting lines pass by.

5. A layout structure of a display panel, comprising:
a plurality of gate lines;
a plurality of source lines, which are interlaced with the gate lines to construct a plurality of pixel units; and
a plurality of connecting lines, which are electrically connected to the gate lines or the source lines in a one-to-one relationship and are extended to the same side or two corresponding sides of the display panel.

6. The layout structure according to claim 5, wherein the connecting lines are source connecting lines which are parallel to the gate lines, corresponding ends of the source connecting lines are electrically connected to the source lines via a plurality of connecting points, respectively.

7. The layout structure according to claim 6, wherein the display panel comprises a source driver, another set of corresponding ends of the source connecting lines are electrically connected to an output terminal of the source driver for receiving data signals outputted from the source driver.

8. The layout structure according to claim 6, wherein the display panel comprises a first metal layer, a second metal layer, and an insulating layer located between the first metal layer and the second metal layer, wherein the gate lines are formed in the first metal layer, the source lines are formed in the second metal layer, and the source connecting lines are formed in the first metal layer and are electrically connected to the source lines formed in the second metal layer via contact holes.

9. The layout structure according to claim 8, further comprising a plurality of common lines, which are formed in the second metal layers and are parallel to the source lines, wherein the common lines have shield structures disposed corresponding to a region where the source connecting lines pass by.

10. The layout structure according to claim 5, wherein the connecting lines are gate connecting lines which are parallel to the source lines, corresponding ends of the gate connecting lines are electrically connected to the gate lines via a plurality of connecting points, respectively.

11. The layout structure according to claim 10, wherein the display panel comprises a gate driver, another set of corresponding ends of the gate connecting lines is electrically connected to an output terminal of the gate driver for receiving scan signals outputted from the gate driver.

12. The layout structure according to claim 10, wherein the display panel comprises a first metal layer, a second metal layer, and an insulating layer located between the first metal layer and the second metal layer, wherein the gate lines are formed in the first metal layer, the source lines are formed in the second metal layer, and the gate connecting lines are formed in the second metal layer and are electrically connected to the gate lines formed in the first metal layer via contact holes.

13. A pixel structure of a display panel, having a transistor, in which the pixel structure is constructed by interlacing two gate lines with two source lines, one gate line that corresponds to the pixel structure transmits a scan signal for turning on the transistor of the pixel structure, and one data line that corresponds to the pixel structure transmits a data signal to the pixel structure when the transistor is turned on, wherein the pixel structure comprises:
a connecting line which is electrically connected to the gate line corresponding to the pixel structure or the source line corresponding to the pixel structure, and is extended to an external portion.

14. The pixel structure according to claim 13, wherein the connecting line is a source connecting line which is parallel to the two gate lines, the source connecting line is electrically connected to the source line that corresponds to the pixel structure via a connecting point.

15. The pixel structure according to claim 13, wherein the connecting line is a gate connecting line which is parallel to the two source lines, the gate connecting line is electrically connected to the gate line that corresponds to the pixel structure via a connecting point.
